(19) United States
(12) Patent Application Publication
(10) Pub. No.: US 2024/0150984 A1
(43) Pub. Date: May 9, 2024

(54) SUCTION DEVICE FOR PARTICLES DURING MACHINING PROCESSING OF TRACK RAILS

(71) Applicant: Schweerbau International GmbH & Co. KG, Stadthagen (DE)

(72) Inventor: Frank Mevert, Lauenhagen (DE)

(21) Appl. No.: 18/503,302

(22) Filed: Nov. 7, 2023

(30) Foreign Application Priority Data
Nov. 9, 2022 (DE) 10 2022 129 601.6

(51) Int. Cl. E01H 8/10; E01B 31/13

(52) U.S. Cl. CPC E01H 8/105; E01B 31/13

(57) ABSTRACT

A suction device includes a plurality of radial fans. Each respective radial fan has a suction opening for drawing in particles that are removed during processing, and an outlet opening for discharging the particles into a collection device. Each radial fan has a fan wheel driven in a rotationally movable manner about a rotation axis. The fan wheel has a circumferential face and an impact face. The impact face faces the suction opening for radially redirecting the particles that strike the impact face. The suction device further includes at least one collection channel circumferentially and partially surrounding the fan wheel of each respective radial fan. The circumferential faces of the fan wheels of adjacent radial fans delimit a roller gap. The collection channel opens in the roller gap.

### CROSS REFERENCE TO RELATED APPLICATIONS

This application claims benefit to German Patent Application No. DE 10 2022 129 601.6, filed on Nov. 9, 2022, which is hereby incorporated by reference herein.

### FIELD

Embodiments of the present invention relate a suction device for particles or other foreign bodies that are produced as a result of machining processing by grinding or milling a plurality of parallel track rails which are intended to be used by rail vehicles. Embodiments of the invention further relate to a mobile processing unit for machining processing, in particular of a track rail for rail vehicles, having such a suction device and a rail vehicle having a processing unit for machining processing which has a suction device.

### BACKGROUND

The processing of the rail head surface for removing waves and cracks and for reprofiling is currently often carried out on the track by means of a material removal processing operation. In order to overcome relatively significant damage, mobile rail milling tools are often used in this case. These comprise one or more milling wheels which are arranged in milling units and which are driven in a motorised manner and which are arranged on a special rail vehicle and are moved by this vehicle along the rails. The feeding is carried out by means of linear axes in at least two directions, wherein, by means of sensors and skids, the relative position with respect to the rail is detected in order by means of an electronic control to thus achieve a precise control of the feeding and the driving of the milling wheels and consequently the desired milling removal. The removed chips are supplied to a container of a collection device and can consequently be recycled.

Screening elements for catching the abrasion particles which are produced during the milling operation are also already known and substantially surround the rail path in the portion in which the processing operation is taking place in order to thus retain in a defined space the abrasion particles and sparks which can then be drawn away via a suction device.

EP 0 340 471 B1 describes a radial fan which is provided with an integrated dirt separator for electric drive vehicles for cooling the travel motors. During operation of the radial fan, there are introduced with the suction air into the radial fan dust and particles which, as a result of their relatively significant mass, are radially separated through openings in a separation space which is in the form of an annular channel and which has a cross section which expands in the rotation direction of the fan and are discharged by means of a pipe.

EP 2 143 958 A1 discloses a radial fan which has a collection channel which surrounds the fan wheel in order, using the rotational movement of the fan wheel alone, to supply a large portion of the particles contained in the fluid to be conveyed under the action of the inertia forces and dynamic forces via the circumferential gap to the collection channel.

U.S. Pat. No. 805,965 A relates to a digger device having a suction pipe and having cutting tools which act at the inlet end of the suction pipe and which are arranged on shafts, wherein the blades of the cutting tool extend in the longitudinal direction of the suction pipe.

CN 1 07 642 490 A discloses a waste water pump which partially conveys a large quantity of foreign bodies. Two shredder blades which are arranged on the shafts serve to roughly comminute and finely comminute the foreign bodies.

DE 21 26 678 A relates to an apparatus for continuous production of dispersions with a high degree of dispersity. To this end, the apparatus has a running wheel and a disc having mutually engaging sprockets, wherein the annular cross sectional faces between the teeth are filled with flowing material.

DE 16 53 802 A discloses a pump for conveying unclean thick liquids which are permeated with fibrous materials, having a pair of screw conveyors which have an opposing inclination direction and in the cutting region of which a radial blade is inserted in such a manner that the thick liquid passes tangentially into this radial blade region. The pump housing may have a ribbed or toothed surface in the region opposite the circumference of the helical face.

In the known mobile suction devices, in practice the comparatively large volume of the collection device which is required to collect the particles and to supply them for disposal or recycling has been found to be disadvantageous. In practice, the possible processing duration during the milling or grinding processing operation is often limited by the volume of the collection device.

### SUMMARY

Embodiments of the present invention provide a suction device. The suction device includes a plurality of radial fans. Each respective radial fan has a suction opening for drawing in particles that are removed during processing, and an outlet opening for discharging the particles into a collection device. Each radial fan has a fan wheel driven in a rotationally movable manner about a rotation axis. The fan wheel has a circumferential face and an impact face. The impact face faces the suction opening for radially redirecting the particles that strike the impact face. The suction device further includes at least one collection channel circumferentially and partially surrounding the fan wheel of each respective radial fan. The circumferential faces of the fan wheels of adjacent radial fans delimit a roller gap. The collection channel opens in the roller gap.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sectioned side view of the suction device according to embodiments of the invention provided with two radial fans;

FIG. 2 shows a plan view of the suction device shown in FIG. 1, according to some embodiments;

FIG. 3 shows an enlarged detailed illustration of the detail III in FIG. 1, according to some embodiments;

FIG. 4 shows an enlarged detailed illustration of the detail IV in FIG. 2, according to some embodiments;

FIG. 5 shows an illustration of the radial fan shown in FIG. 2 in a state sectioned along the line V-V, according to some embodiments; and

FIG. 6 shows a perspective illustration of the suction device according to some embodiments.

### DETAILED DESCRIPTION

Embodiments of the invention provide a simple possibility for subsequent processing of the particles or foreign bodies in order to thus extend the processing duration. Furthermore, embodiments of the invention provide a mobile processing unit and a rail vehicle which is provided therewith and which has an extended processing duration.

According to some embodiments, a suction device includes a plurality of radial fans. Each radial fan is provided with a suction opening for drawing in the particles which are removed during processing and an outlet opening for discharging the particles into a collection device and wherein the radial fan has a fan wheel which is driven in a rotationally movable manner about a rotation axis and which has a circumferential face and an impact face which faces the suction opening for radially redirecting the particles or foreign bodies which strike the impact face.

According to some embodiments of the invention, the suction device has at least two radial fans which are arranged parallel with each other with spacing and which are associated with different track rails and which each have a collection channel which circumferentially delimits an annular gap with the circumferential face of the fan wheel at a circumferential angle between 200° and 300°, in particular approximately 270°, wherein the fan wheels of adjacent radial fans of the suction device delimit together with the respective circumferential face thereof a tangential roller gap with a gap width greater than zero or rolling or meshing on each other, and in that the respective collection channel of the different adjacent fan wheels opens in this roller gap so that at least a significant proportion of more than 50% of the supplied particles flows through the roller gap, wherein the region in the flow direction behind the narrow location of the roller gap forms the outlet opening for the exhaust air flow and the particles and foreign bodies which are also carried therein. By the particles or foreign bodies not being supplied to the collection device simply in an unprocessed state according to embodiments of the invention, but instead being guided through the roller gap between the adjacent fan wheels beforehand, they are deformed or comminuted, in particular smoothed or broken, in the correspondingly adapted and preferably adjustable roller gap, with the result that the volume is reduced and consequently the density of the particles and foreign bodies in the collection device is significantly increased. In a surprisingly simple manner, the suction device in addition to its main function of transporting away the removed particles and foreign bodies, can consequently also perform the function of subsequent processing in order to reduce the volume without an additional unit or additional energy consumption being required for this. By, in this manner, better use being made of the available container volume of the collection device by receiving a larger mass of particles, the operating time which in practice is significantly limited by the filling level of the collection device and the required emptying is significantly increased.

The fan wheels may also be configured to be able to be moved relative to each other and to be pretensioned with respect to each other with a predefined pretensioning so that chips which pass through are acted on with a pretensioning force and are thereby deformed.

In an embodiment of the invention, the cross sectional surface-area of the collection channel decreases in the flow direction or rotation direction. There is thereby produced inside the collection channel a nozzle effect which leads to an acceleration of the air flow so that the carried particles enter the roller gap at an increased speed and are thereby comminuted in a more effective manner. In addition, an additional impact face may also be provided in the region of the outlet opening of the roller gap, in particular opposite it, in order to thus use the kinetic energy of the particles for additional compression of the particles.

The circumferential faces of the adjacent fan wheels could have a complementary contour and could preferably form a roller gap of constant width which, for example, follows a bent path by one circumferential face being configured in a convex manner and the other circumferential face being configured in a concave manner. In contrast, it is practical for the circumferential face of the respective fan wheel to be formed by the covering face of a rotationally symmetrical, in particular cylindrical fan wheel so that the entire length of the roller gap is acted on in a manner parallel with the rotation axis of the fan wheels simultaneously with the supplied particles or foreign bodies.

In an embodiment of the invention, the collection channel encloses at least in a region adjacent to the roller gap the circumferential face and the impact face and/or a rear side in a limiting manner with a small gap between 0.5 mm and 10 mm. The solid components which are also carried in the air flow are thereby prevented from bypassing the roller gap, in particular therefore flowing along the impact face or the rear side and thereby reaching the collection device in an unprocessed state. In order to prevent possible clogging, a bypass proportion of up to 25% of the carried particles may be provided by means of corresponding tolerance measurements of the collection channel.

According to embodiments of the invention, it is not excluded that the respective collection channel may meet the roller gap at, for example, an acute angle with respect to the rotation axis. In contrast, an embodiment of the invention is practical in which the collection channel opens tangentially in the roller gap between the fan wheels and in particular extends parallel with the main extent plane of the fan wheels. In this instance, the collection channel preferably has parallel with the rotation axis a width which is no larger or only slightly larger than the width of the circumferential face between the impact face and the rear side of the fan wheels.

The circumferential faces of the fan wheels which delimit the roller gap may be configured in a cylindrical manner, wherein the diameters may be different. In contrast, it is advantageous for the fan wheels which delimit a common roller gap, in particular at least the respective circumferential faces, to have corresponding dimensions.

Furthermore, it has been found to be advantageous for the size of the roller gap to be able to be adjusted, for example, by changing the spacing of the parallel rotation axis of the two fans so that the roller gap can be adapted to the size and other features of the particles or foreign bodies and undesirable blockages in the roller gap can be avoided. During operation of the suction device, in a cyclical manner or as a result of detected measurement values, a change of the size of the roller gap may also be provided in order, for example, by means of a temporary increase of the roller gap to remove adhering particles in the input region by means of increased flow speeds.

The cylindrical circumferential faces could have a smooth or rough surface nature. Furthermore, the circumferential faces may have a helically corrugated nature or helical recesses or projections with an inclination with respect to the rotation axis. According to another embodiment of the invention, the circumferential faces have a structuring and/or contouring having in particular groove-like or channel-like parallel recesses which can engage inside each other so that the protrusions or projections on the first circumferential face engage in the corresponding recesses of the second circumferential face. Larger contact faces for the carried particles are thereby produced, whereby a relatively high degree of deformation, which leads to an effective breaking of the chips which enter the roller gap, is achieved.

For example, the circumferential faces have rotationally symmetrical radial projections which delimit in an axial direction a plurality of parallel groove-like or channel-like recesses and which engage in adjacent recesses or projections.

In an embodiment, the circumferential face has in a circumferential direction a cyclically increasing and decreasing contour which engages in a meshing manner in a corresponding contour of the adjacent circumferential face. There are thereby produced in a manner similar to a gear mutually meshing contact faces between the different circumferential faces by means of which the additional shearing forces are applied to the enclosed particles in order to thus achieve an effective comminution.

In order to achieve an optimum radial redirection of the axially introduced flow and the carried particles and foreign bodies, the impact face for radial flow redirection is provided with in particular welded-on webs which extend in particular orthogonally with respect to the surface of the impact face.

Embodiments of the invention also provide a mobile processing unit for machining processing of a track rail for rail vehicles having a suction device, wherein the mobile processing unit can be connected permanently or temporarily to a vehicle as a carrier.

Furthermore, an autonomous processing unit may be produced with a collection device by a rail vehicle being provided with a processing unit which has a suction device for machining processing.

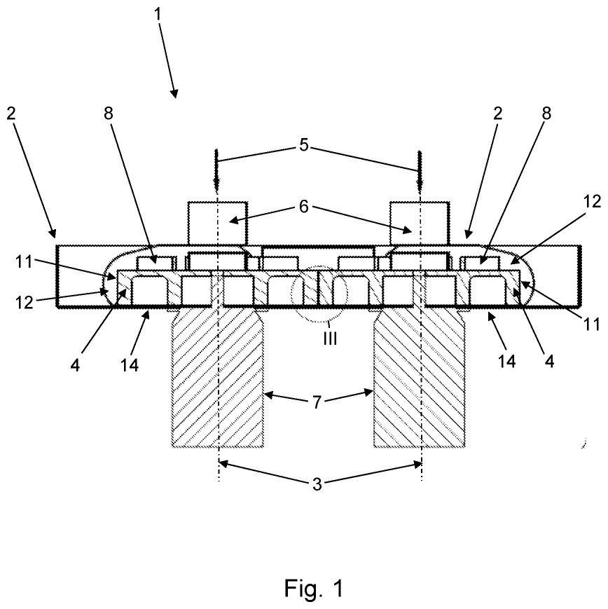

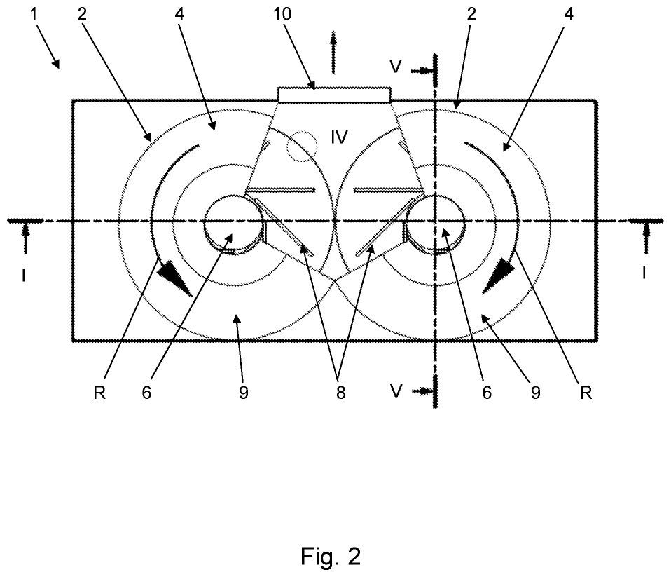

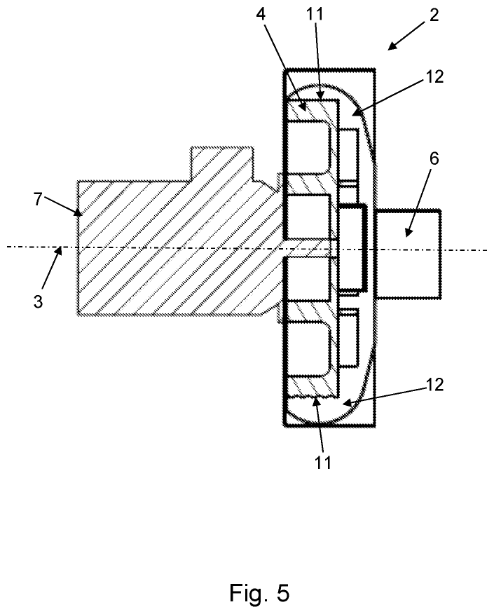

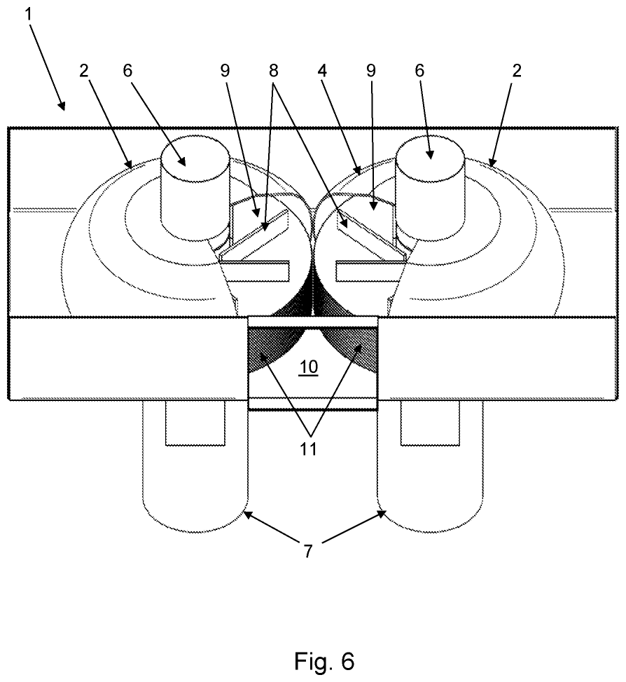

The suction device 1 according to an embodiment of the invention is explained in greater detail below with reference to FIGS. 1 to 6. The suction device 1 has two radial fans 2 for drawing off particles, in particular chips, as typically produced as a result of a material-removing processing operation. Each radial fan 2 of the illustrated construction type is associated in each case with one of two parallel track rails of the rail traffic in order to thus prevent during the rail processing the undesirable introduction of foreign bodies into the track bed. In this instance, embodiments of the invention are not limited to rail processing.

The particles which are removed from the track and other foreign bodies from the track bed are supplied to a suction opening 6 together with the air flow 5 which is drawn axially with respect to the respective rotation axis 3 of a respective fan wheel 4. As a result of the fan wheels 4 which are caused to rotate in the arrow direction R by means of a respective drive 7, the air flow 5 and the solid materials which are carried therein are radially redirected on an impact face 9 which is provided with welded-on strips 8 and supplied to an outlet opening 10 in order to discharge the particles into a collection device which is not shown. Each fan wheel is cylindrical in terms of the basic shape thereof and has in the example illustrated a circumferential face 11 which is concentric with respect to the rotation axis 3 and which is partially circumferentially enclosed by a collection channel 12. The particles accumulate as a result of their inherent mass in an annular gap which is delimited between the collection channel 12 and a circumferential face 11 of the fan wheel 4 and are carried along in the circumferential direction by the air flow 5. In this instance, the cross sectional shape and surface-area of the collection channel 12 changes in the flow direction in such a manner that, on the one hand, an acceleration of the flow begins and, on the other hand, the collection channel 12 is formed in such a manner that it laterally surrounds the impact face 9 and a rear side 14 which is parallel therewith with a decreasing axial spacing. Accordingly, the air flow is concentrated between the region which is delimited by the plane of the impact face 9 and by the plane of the rear side 14. In the continued flow path, the air flow enters in a tangential manner the roller gap S which is delimited by the two circumferential faces 11 and which is sized in such a manner that there is a mechanical action of force on the particles. Long chips are thus smoothed and broken so that the bulk volume in the collection device is significantly reduced. To this end, the roller gap S can be adjusted by means of a parallel displacement of the fan wheels 4 in the direction of the double-headed arrow 13 and can thus be optimally adapted to the respective conditions of use.

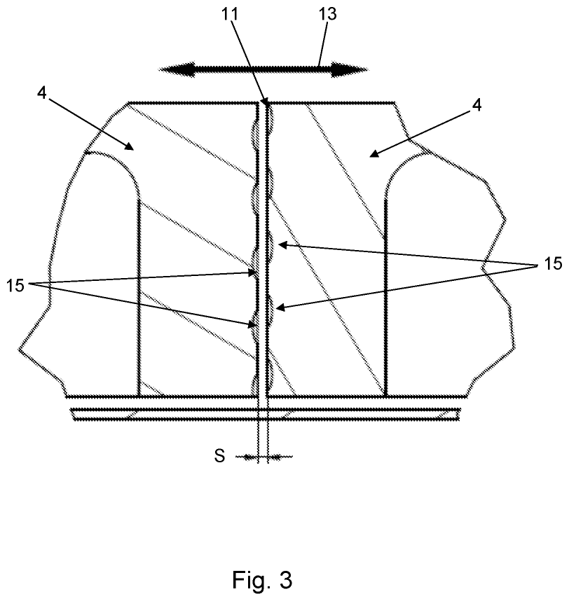

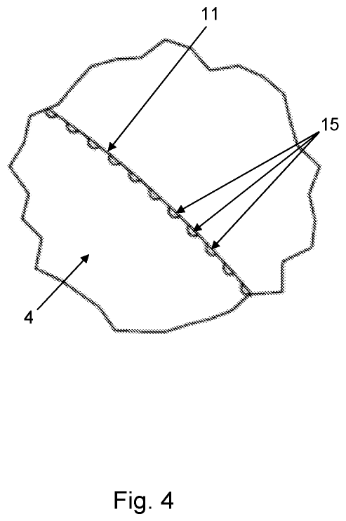

As can be seen in particular in FIGS. 3 and 4, the circumferential faces 11 are provided with regular structuring 15 which extend both in a circumferential direction and in a transverse direction parallel with the rotation axis 3. The contact face between the circumferential face 11 and the particles is thereby increased, wherein there is an improved deformation as result of increased shearing forces and at the same time the risk of adhesion of particles is decreased.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Suction device
2 Radial fan
3 Rotation axis
4 Fan wheel
5 Air flow
6 Suction opening
7 Drive
8 Strip
9 Impact face
10 Outlet opening
11 Circumferential face
12 Collection channel
13 Double-headed arrow
14 Rear side
15 Structuring
R Arrow direction
S Roller gap

1. A suction device comprising:
a plurality of radial fans, wherein each respective radial fan has a suction opening for drawing in particles that are removed during processing, and an outlet opening for discharging the particles into a collection device, and wherein each radial fan has a fan wheel driven in a rotationally movable manner about a rotation axis, the fan wheel has a circumferential face and an impact face, the impact face faces the suction opening for radially redirecting the particles that strike the impact face; and
at least one collection channel circumferentially and partially surrounding the fan wheel of each respective radial fan, wherein the circumferential faces of the fan wheels of adjacent radial fans delimit a roller gap, and wherein the collection channel opens in the roller gap.

2. The suction device according to claim 1, a cross sectional surface-area of the collection channel decreases continuously in a flow direction.

3. The suction device according to claim 1, wherein the circumferential face of the fan wheel is formed by a covering face of the fan wheel that is a rotationally symmetrical.

4. The suction device according to claim 1, wherein the collection channel encloses, at least in a region adjacent to the roller gap, the circumferential face, the impact face, and/or a rear side, in a limiting manner with a small gap.

5. The suction device according to claim 1, wherein the collection channel opens tangentially in the roller gap between the fan wheels of adjacent radial fans.

6. The suction device according to claim 1, wherein the size of the roller gap is adjustable.

7. The suction device according to claim 1, wherein the circumferential has groove-like or channel-like parallel recesses.

8. The suction device according to claim 1, wherein the circumferential face has, in a circumferential direction, a cyclically increasing and decreasing contour that engages a corresponding contour of the circumferential face of the adjacent fan wheel.

9. A processing unit for machining processing of a track rail for rail vehicles, the processing unit having a suction device according to claim 1.

10. A rail vehicle having a processing unit which has a suction device for machining processing according to claim 1.
